(19) United States
(12) Patent Application Publication
(10) Pub. No.: US 2026/0230854 A1
(43) Pub. Date: Aug. 6, 2026

(54) METHOD OF ADVANCED GNB-UE MODEL MONITORING

(71) Applicant: Continental Automotive Technologies GmbH, Hannover (DE)

(72) Inventors: Hojin Kim, Regensburg (DE); Rikin Shah, Langen, Hessen (DE); Reuben George Stephen, Singapore (SG); Andreas Andrae, Frankfurt am Main (DE)

(73) Assignee: Continental Automotive Technologies GmbH, Hannover (DE)

(21) Appl. No.: 19/152,566

(22) PCT Filed: Feb. 1, 2024
(86) PCT No.: PCT/EP2024/052540

§ 371 Date: Jul. 31, 2025

(30) Foreign Application Priority Data
Feb. 3, 2023 (DE) 10 2023 200 914.5

(51) Int. Cl. H04W 24/02; G06N 20/00

(52) U.S. Cl. CPC H04W 24/02; G06N 20/00

(57) ABSTRACT

The present disclosure describes methods of configuring AI/ML based model monitoring and signaling of activating/de-activating model monitoring in wireless mobile communication system including base station (e.g., gNB) and mobile station (e.g., UE). In AI/ML model is applied to radio access network, model performance such as inferencing is monitored so that any potential drift occurrence can be detected to ensure the required communication quality. Depending on the applied model characteristics and channel environments, model monitoring is configured to support varying monitoring cycles in association with different patterns of drift occurrences in model lifecycle.

### CROSS REFERENCE TO RELATED APPLICATIONS

This application is the U.S. National Phase Application of PCT International Application No. PCT/EP2024/052540, filed Feb. 1, 2024, which claims priority to German Patent Application No. 10 2023 200 914.5, filed Feb. 3, 2023, the contents of such applications being incorporated by reference herein.

### TECHNICAL FIELD

The present disclosure relates to AI (artificial intelligence)/ML (machine learning) based model monitoring, where techniques for configuring and signaling the specific information to avoid model performance degradation are presented.

### BACKGROUND

In December 2021, the release-18 package of 3GPP (Third Generation Partnership Project) has been approved and one of the selected study items is AI/ML (artificial intelligence/machine learning) as described in the related document (RP-213599) addressed in 3GPP TSG (Technical Specification Group) RAN (Radio Access Network) meeting #94e. The official title of AI/ML study item is “Study on AI/ML for NR Air Interface”, and currently RAN WG1 (Working Group 1) and WG2 are actively working on specification. The goal of this study item is to identify a common AI/ML framework and areas of obtaining gains using AI/ML based techniques with use cases. In radio access network perspective, one of key areas for work scope is to identify various levels of collaboration between base station (BS/gNB) and user equipment (UE).

According to 3GPP, the main objective of this study item is to study AI/ML framework for air-interface with target use cases by considering performance, complexity, and potential specification impact. In particular, AI/ML model, terminology and description to identify common and specific characteristics for framework will be one of key work scope. For the selected target use cases, two issues will be included such as evaluation of performance benefits and assessment of potential specification impact. Regarding AI/ML framework, various aspects are under consideration for investigation and one of key items is about lifecycle management of AI/ML model where multiple stages are included as mandatory for model training, model deployment, model inference, model monitoring, model updating etc. In 3GPP TSG RAN WG1 #110bis meeting, one of key agreements is to study multiple metrics/methods for AI/ML model monitoring in lifecycle management per use case and AI/ML model monitoring has been identified as one of key issues because drift always occurs during AI/ML model operation as model performance is degraded with time-varying environments. Once drift is detected after model monitoring, a countermeasure is needed to compensate for model performance degradation or to maintain the required KPIs.

On the other hand, in 3GPP the terminologies of working list contains a set of high-level descriptions about AI/ML model training, inference, validation, testing, UE-side model, network-side model, one-sided model, two-sided model, etc. UE-sided model and network-sided model indicate that AI/ML model is located for operation in UE and network side, respectively. In the similar context, one-sided and two-sided model indicate that AI/ML model is located in one side and two sides, respectively. All signaling aspects to support the above items are currently not specified yet as definitions of terminologies are still under discussion for further modifications. Any potential standards impact with new or enhanced mechanisms of supporting AI/ML model with the above working list items is one of key areas for investigation in AI/ML study item.

Currently, there is no mechanism to allow UE to reduce model monitoring cycle without the related specification. As a result, UE keeps monitoring model operation which increases power consumption

WO 2021/044192, incorporated herein by reference, discloses a method and system for detection and/or prediction of data drift in e.g., distributed clouds.

US 2021/0256310, incorporated herein by reference, describes the machine learning platform deploying the machine learning model and monitors a performance of the machine learning model after deployment.

US 2019/0147371, incorporated herein by reference, describes a device identifying training data and scoring data for a

model, and removes bias from the training data to generate unbiased training data.

WO 2022/182272, incorporated herein by reference, provides network analysis methods and apparatuses that may identify unexpected behaviour of a component in a communications network without requiring measurements of performance on an individual component level.

WO 2022/008037, incorporated herein by reference, relates UE's (in-)ability to execute and/or train a ML model and to network-initiated triggering of execution and/or training of the ML model in view

of UE's (in-)ability to execute and/or train a ML model.

US 2020/0151619, incorporated herein by reference, describes the impact of concept drift in selecting machine learning training methods to address the identified impact.

### SUMMARY OF THE INVENTION

An aspect of the invention aims to provide a solution of the problem how to make efficient model monitoring mechanism when AI/ML model is operated in radio access network.

The solution is given by activation of model monitoring is configured by gNB whereby UE performs model monitoring based on the configured monitoring cycle.

UE only monitors model based on the configured cycle, which reduces device power consumption. AI/ML model monitoring is a key issue as it is because drift always occurs during AI/ML model operation as model performance is degraded with time-varying environments.

According to a first aspect, the present disclosure relates to a method of activation of model monitoring that is configured by gNB, whereby UE performs model monitoring based on the configured monitoring cycle, whereby, gNB sends model monitoring configuration information to UE through RRC signaling, and Model monitoring cycle for UE is re-configured by gNB through RRC message based on the AI/ML model in operation between gNB and UE.

In some embodiments of the method according to the first aspect, the method is characterized by that for a group of UEs with the same AI/ML model, the configured model monitoring is applied to multiple UEs in a group.

In some embodiments of the method according to the first aspect, the method is characterized by that gNB enables/disables model monitoring of UE.

In some embodiments of the method according to the first aspect, the method is characterized by that indication message to enable/disable model monitoring is sent through PDCCH/MAC CE (UE specific) and system information (to all UEs) for UE(s).

In some embodiments of the method according to the first aspect, the method is characterized by that the indication message is sent to UE so as to stop or temporarily disable model monitoring while model monitoring is re-configured for update when gNB determines model re-training or model switching during model monitoring operation.

In some embodiments of the method according to the first aspect, the method is characterized by that gNB can configure different monitoring configurations depending on RRC state such that:
In RRC_CONNECTED state, gNB can configure monitoring information through dedicated RRC message.
In RRC_INACTIVE state, gNB can configure monitoring information through system information message.
In RRC_IDLE state, gNB can configure monitoring information through RRC release message.

In some embodiments of the method according to the first aspect, the method is characterized by that both one-sided model and two-sided model can apply model monitoring signaling and the associated configuration information.

In some embodiments of the method according to the first aspect, the method is characterized by that one of model deployment case, model monitoring is determined to activate or de-activate by UE based on assistance information from gNB.

According to a second aspect, the present disclosure relates toa wireless device comprising at least one memory and at least one processor configured to carry out a method according according to any one of the embodiments of the first aspect.

According to a third aspect, the present disclosure relates to a user equipment, UE, comprising a wireless device according to any one of the embodiments of the present disclosure.

According to a fourth aspect, the present disclosure relates to a base station, BS, comprising at least one memory and at least one processor configured to carry out a method according to any one of the embodiments of the first aspect.

According to a fifth aspect, the present disclosure relates to a wireless communication system comprising at least one base station according according to any one of the embodiments of the present disclosure and at least one user equipment according according to any one of the embodiments of the present disclosure.

According to a sixth aspect, the present disclosure relates to a computer program product comprising instructions which, when executed by at least one processor, configure said at least one processor to carry out a method according to the first aspect said at least one processor to carry out a method for exchanging data according to any one of the embodiments of the present disclosure. The computer program product can use any programming language, and can be in the form of source code, object code, or in any intermediate form between source code and object code, such as in a partially compiled form, or in any other desirable form. According to a sixth aspect, the present disclosure relates to a computer-readable storage medium comprising instructions which, when executed by at least one processor, configure said at least one processor to carry out a method according to any one of the embodiments of the present disclosure.

### BRIEF DESCRIPTION OF THE DRAWINGS

FIG. 1 shows a flowchart of gNB behavior for model monitoring configuration and the associated downlink signaling.

FIG. 2 shows a flowchart of UE behavior for model monitoring operation along with reception of model monitoring configuration.

FIG. 3 shows a signaling flow of gNB-UE communication for model monitoring operation.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the fimctions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Also, the order of steps of any methods disclosed herein, in particular in the figures, is provided only for illustration purposes and is not meant to limit the present disclosure which may be applied with the same steps executed in a different order and/or with all or part of the steps executed in parallel or jointly, unless a step is explicitly described as following or preceding another step and/or where it is implicit that a step must follow or precede another step. Also, in a figure, steps represented surrounded by a dashed line are to be considered as optional for the embodiment represented in this figure. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

The following explanation will provide the detailed description of the mechanism about AI/ML-based model monitoring operation in radio access network. AI/ML based techniques are currently applied to many different applications and 3GPP also started to work on its technical investigation to apply to multiple use cases based on the observed potential gains.

AI/ML lifecycle can be split into several stages such as data collection/pre-processing, model training, model testing/validation, model deployment/update, model monitoring etc., where each stage is equally important to achieve target performance with any specific model(s).

In applying AI/ML model for any use case or application, one of the challenging issues is to manage the lifecycle of AI/ML model. It is mainly because the data/model drift occurs during model deployment/inference and it results in performance degradation of AI/ML model. Fundamentally, the dataset statistical changes occur after model is deployed and model inference capability is also impacted with unseen data as input. In a similar aspect, the statistical property of dataset and the relationship between input and output for the trained model can be changed with drift occurrence.

To handle this issue, AI/ML model needs model monitoring after deployment because model performance cannot be maintained continuously due to drift and update feedback is then provided to re-train/update the model or select alternative model. Therefore, AI/ML data/model drift handling is highly important by tracking model performance such as predictability, accuracy, etc.

When AI/ML model enabled wireless communication network is deployed, it is then important to consider how to handle AI/ML model monitoring with drift for wireless devices under operations such as model training, inference, updating, etc. In parallel, other aspect is how to handle the increase of power consumption to perform model monitoring so that model performance degradation need to be detected closely.

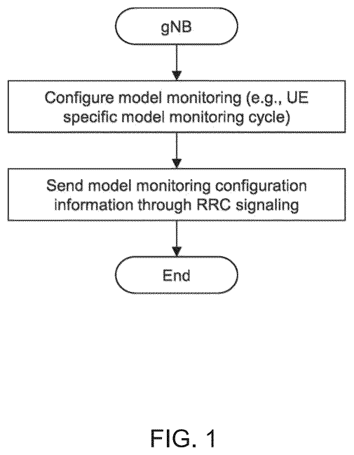

FIG. 1 shows a flowchart of gNB behavior when model monitoring is configured and the associated downlink signaling is generated for UE. Activation of model monitoring is configured by gNB whereby UE performs model monitoring based on the configured monitoring cycle. Specifically, gNB configures model monitoring (e.g., UE specific model monitoring cycle) and model drift pattern learning can be used as reference before model monitoring configuration because drift pattern can vary depending on model characteristics and applications/environments. Model monitoring can be then adapted as well for configuration and model drift pattern learning phase can help. After model monitoring information is configured, it is then sent to UE and radio resource control (RRC) signaling can be used for this transmission. In other aspect, when there are a group of UEs with the same AI/ML model in use, the configured model monitoring can be applied to multiple UEs in a group based on the configured metrics such as the same UE priority or other QoS parameters. For model monitoring operation, gNB can configure different monitoring configurations depending on RRC state. For example, in RRC_CONNECTED state gNB can configure monitoring information through dedicated RRC message. In RRC_INACTIVE state, gNB can configure monitoring information through system information message. In RRC_IDLE state, gNB can configure monitoring information through RRC release message.

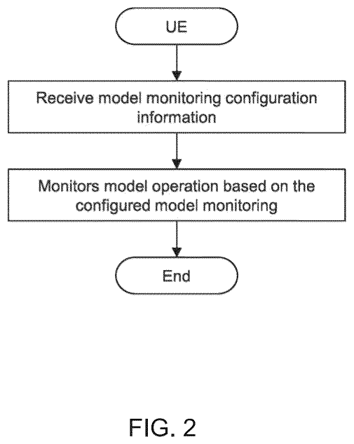

FIG. 2 shows a flowchart of UE behavior when configuration information for model monitoring is received and model operation is monitored. UE is signaled to activate the configured model monitoring when the associated information is received from gNB and UE-specific model monitoring cycle is then applied so that power consumption due to monitoring operation can be also reduced. Depending on different model performance behavior, the configured model monitoring information helps UE reduce the device battery power consumption as model monitoring cycle is adjusted as well. Any specific model monitoring cycle for application is implementation-specific and the configuration information can contain a set of parameters related to apply adjustment of model monitoring cycle and its characteristics. In other aspect, depending on model operation scenarios, model monitoring can be also determined to activate or de-activate by UE based on assistance information from gNB. By default, gNB provides signaling information about enable/disable model monitoring with configuration information and UE can also overrule the indication message to activate or de-activate model monitoring with configuration information for model monitoring.

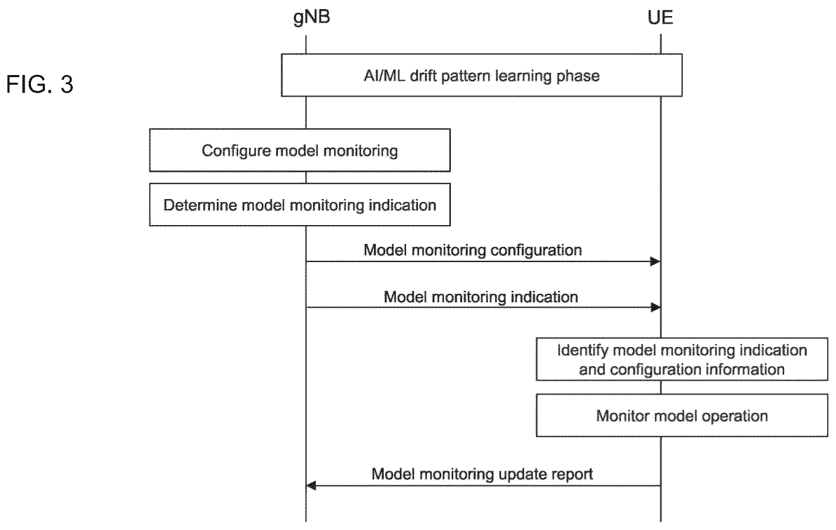

FIG. 3 shows a signaling flow of gNB-UE communication when model monitoring operation is applied. Between gNB and UE, model drift pattern learning can be operated so that model performance can be learned through drift occurrence behavior since different models can have different drift patterns based on applications and environments. Model drift pattern information helps when model monitoring is performed for any drift detection or performance degradation events. gNB configures model monitoring (e.g., UE specific model monitoring cycle) and the configured model monitoring information can be sent through RRC signaling. For example, gNB can generate a set of model monitoring patterns as index values (e.g., monitoring cycles) so that UE behavior can be commanded for the configured model monitoring operation. Using model monitoring update report from UE, gNB can re-configure model monitoring information by adjusting monitoring cycle.

Depending on the status of model operation, gNB also enables/disables model monitoring of UE and the indication message to enable/disable model monitoring is sent through PDCCH/MAC CE (UE specific) and system information (to all UEs) for UE(s). The configurable criteria to enable/disable model monitoring is sent by network. For example, when gNB determines model re-training or model switching during model monitoring operation, the indication message is sent to UE so as to stop or temporarily disable model monitoring while model monitoring is re-configured for update.

In other aspect, both one-sided model and two-sided model can apply model monitoring signaling and the associated configuration information, where one-sided model is defined as either network-sided model or UE-sided model and two-sided model as paired model between gNB and UE for joint model operation.

This application is intended to provide fundamental mechanisms of interworking and data information flow in radio access network collaboration for AI/ML support.

Based on the proposed application, gNB-UE behaviors for supporting AI/ML operation for wireless communication can be greatly improved with the potential scenarios such as two-sided AI/ML model.

1. Method of activation of model monitoring that is configured by gNB, whereby UE performs model monitoring based on the configured monitoring cycle, whereby,
gNB sends model monitoring configuration information to UE through RRC signaling; and
the model monitoring cycle for UE is re-configured by gNB through RRC message based on the AI/ML model in operation between gNB and UE.

2. The method according to claim 1, wherein for a group of UEs with the same AI/ML model, the configured model monitoring is applied to multiple UEs in a group.

3. The method according to claim 1, wherein gNB enables/disables model monitoring of UE.

4. The method according to claim 1, wherein indication message to enable/disable model monitoring is sent through PDCCH/MAC CE (UE specific) and system information (to all UEs) for UE(s).

5. The method according to claim 1, wherein the indication message is sent to UE so as to stop or temporarily disable model monitoring while model monitoring is re-configured for update when gNB determines model re-training or model switching during model monitoring operation.

6. The method according to claim 1, wherein gNB can configure different monitoring configurations depending on RRC state such that:
In RRC_CONNECTED state, gNB can configure monitoring information through dedicated RRC message;
In RRC_INACTIVE state, gNB can configure monitoring information through system information message; and
In RRC_IDLE state, gNB can configure monitoring information through RRC release message.

7. The method according to claim 1, wherein both one-sided model and two-sided model can apply model monitoring signaling and the associated configuration information.

8. The method according to claim 1, wherein one of model deployment case, model monitoring is determined to activate or de-activate by UE based on assistance information from gNB.

9. A wireless device comprising at least one memory and at least one processor configured to carry out a method according to claim 1.

10. A user equipment, UE, comprising a wireless device according to claim 9.

11. A base station, BS, comprising at least one memory and at least one processor configured to carry out a method according to claim 1.

12. A wireless communication system comprising at least one base station comprising at least one memory and at least one processor and at least one user equipment comprising a wireless device comprising at least one memory and at least one processor each configured to carry out a method according to claim 1.

13. A computer program product comprising instructions which, when executed by at least one processor, configure said at least one processor to carry out a method according to claim 1.

14. A non-transitory computer-readable storage medium comprising instructions which, when executed by at least one processor, configure said at least one processor to carry out a method according to claim 1.
